(19) United States
(12) Patent Application Publication
(10) Pub. No.: US 2006/0139638 A1
(43) Pub. Date: Jun. 29, 2006

(54) Multiparametric cell identification and sorting method and associated device

(75) Inventors: Torsten Muller, Berlin (DE); Stefan Hummel, Haseldorf (DE); Annette Pfennig, Berlin (DE); Gabriele Gradl, Berlin (DE); Axel Bonsen, Hamburg (DE); Rudiger Meyer, Hamburg (DE)

Correspondence Address: THE LAW OFFICE OF RANDALL T. ERICKSON, P.C., 425 WEST WESLEY STREET, SUITE 1, WHEATON, IL, 60187, US

(73) Assignee: Evotec Technologies GmbH

(21) Appl. No.: 10/544,463

(22) PCT Filed: Feb. 4, 2004
(86) PCT No.: PCT/EP04/01034

§ 371 Date: Dec. 13, 2005

(30) Foreign Application Priority Data
Feb. 5, 2003 (DE) 103 04 653.4
Mar. 9, 2003 (DE) 103 20 956.5

(51) Int. Cl. G01N 21/00; G01N 21/64; G01N 15/02

(52) U.S. Cl. 356/342; 356/335; 356/336; 422/82.07; 356/72

(57) ABSTRACT

The invention relates to an method of analysing biological particles, in particular to be conducted in a cell sorter, with following steps: placing the particles to be analysed into a carrier flow, carrying out a first analysis of the particles moving with the carrier flow, selecting at least one particle in dependence on the result of the first analysis, carrying out a second analysis of the selected particle in a decelerated condition. Furthermore, the invention comprises a corresponding analysis device.

The invention relates to a method for analysing preferably biological particles, in particular for analysing biological cells in a cell sorter, according to claim 1, as well as to a corresponding analysing device according to claim 14.

From Müller, T. et al.: “A 3-D microelectrode system for handling and caging single cells and particles”, Biosensors and Bioelectronics 14 (1999) 247-256, a method for analysing biological cells is known, in which method the cells to be analysed are suspended in a carrier flow of a microfluidic system and are dielectrophoretically manipulated and sorted. In the carrier flow, the cells to be analysed are first lined up by a funnel-shaped dielectrophoretic electrode arrangement, and then held in a dielectrophoretic cage so that the cells located in the cage can be analysed in their resting state, for which purpose microscopic, spectroscopic or optical fluorescence analysis methods can be used. Depending on the analysis of the cells trapped in the dielectrophoretic cage, these cells can subsequently be sorted, for which purpose an operator controls a sorting device comprising a dielectrophoretic electrode arrangement which is arranged in the carrier flow downstream of the dielectrophoretic cage.

The above-described known method for analysing cells is associated with a disadvantage in that the cells to be analysed are often very different in a sample. In the case of greatly heterogeneous samples, from which for example certain target cells are to be identified by a method, with these target cells then having to be isolated, the target cells often account for only a small fraction of the entire sample. The other cells do not have the desired characteristics or are no longer vital, i.e. they are already dead. Furthermore, it often happens that the cells are not completely singled out, but instead that many cells pass through the system as aggregations of two or more cells. This is an undesirable result. However, detailed analysis of individual cells or aggregations in a field cage is a time-consuming process so that analysis of the entire cell sample in the field cage would take a very long time.

It is thus the object of the invention to improve the above-described known method for analysing cells such that analysis of biological cells or cell agglomerations that are of no interest (e.g. dead cells) in the dielectrophoretic cage can be avoided.

Starting from the known method for analysing cells, as described in the introduction, this object is met by the features of claim 1, or—in relation to a corresponding analysing device—by the features of claim 14.

The invention comprises the general technical teaching according to which, prior to analysing in the dielectrophoretic cage, the particles suspended in the carrier flow are first subjected to a preliminary analysis of the particles moving with the carrier flow so that the particles of interest for further analysis can subsequently be trapped and analysed in the dielectrophoretic cage.

The preliminary investigation can for example relate to the intensity of a fluorescence, the vitality of a cell and/or the question of whether a single cell or an aggregation is involved. Furthermore, during the preliminary investigation it can be determined whether cells or materials are involved which in shape and size are not the primary objective of closer analysis, for example impurities or other cells, provided they differ from the target cells.

Thus in the method according to the invention for analysing cells first a preliminary analysis of the particles suspended in the carrier flow and a selection of certain particles take place depending on the result of the preliminary analysis, while the actual principal analysis is only carried out in relation to the previously selected particles which for this purpose are decelerated so as to make possible a meaningful principal analysis which would be made more difficult if the particles were moving.

Within the scope of the invention it is not mandatory for the particles selected depending on the preliminary analysis to be completely brought to a halt prior to the principal analysis, for example by trapping these particles in an dielectrophoretic cage. Instead, within the scope of the invention it is also possible for the particles selected depending on the preliminary analysis to be decelerated in the particle stream only to such an extent that a meaningful analysis of the particles becomes possible.

Furthermore, it should be mentioned that in the context of this invention the term “particle” is to be understood in a general sense rather than being limited to individual biological cells. Furthermore, this term also includes synthetic or biological particles, wherein particular advantages arise if the particles are biological materials, for example biological cells, cell groups, cell components or biologically relevant macromolecules, each if applicable in association with other biological particles or synthetic carrier particles. Synthetic particles can comprise solid particles, liquid particles, particles delimited from the suspension medium, or multiphase particles which form a separate phase in relation to the suspension medium in the carrier flow.

Preferably, the particle selected depending on the preliminary analysis and analysed in more detail in the context of the principal analysis is sorted and/or treated depending on the result of the principal analysis. For example, in the principal analysis various cell types can be differentiated and subsequently can be sorted accordingly. It is however also possible for the particles selected in the context of the preliminary analysis to be manipulated by dielectrophoretic elements depending on the result of the principal analysis, wherein the dielectrophoretic elements described in the above-mentioned publication of Müller, T. et al. can be used.

Within the context of the preliminary analysis, for example, a transmitted-light analysis, fluorescence analysis and/or impedance spectroscopy can be carried out. However, in the preferred embodiment of the invention first a transmitted-light analysis is carried out, followed by a fluorescence analysis, wherein the transmitted-light analysis and the fluorescence analysis preferably take place in spatially separated regions of interest. The transmitted-light analysis can for example allow a differentiation between living and dead biological cells, while fluorescence analysis can be used to investigate whether the particles suspended in the carrier flow carry a fluorescence marker.

If within the scope of the preliminary analysis both a transmitted-light analysis and a fluorescence analysis are carried out in spatially separated regions of interest, it is advantageous if the region of interest for the transmitted-light analysis is situated in the carrier flow upstream of the region of interest for the fluorescence analysis. However, as an alternative it is also possible for the region of interest for the transmitted-light analysis to be arranged in the carrier flow downstream of the region of interest for the fluorescence analysis.

Preferably, within the scope of the preliminary analysis of the particles moving with the carrier flow an optical image is taken, which makes possible digital image evaluation for classifying the particles. Preferably, in this process the particles are morphologically analysed, for example to make it possible to differentiate a single biological cell from a cell agglomeration. The term “optical image” used in the context of the present description is however to be interpreted in a general sense and is not limited to two-dimensional images in the traditional sense of the term. Instead, in the context of the present invention the term “optical image” also includes point-shaped or line-shaped optical scanning of the carrier flow or of the particles suspended in the carrier flow. For example, the brightness along a line across the carrier flow channel can be superintegrated for the purpose of detecting and classifying individual particles.

In a transmitted-light analysis the differentiation between living and dead cells can take place by evaluating the intensity distribution in the optical image taken. For example phase-contrast illumination is a special principle of such a transmitted-light analysis. In transmitted-light analysis living biological cells have an annular structure wherein the margin is relatively bright and the centre is darker, while dead biological cells are approximately uniform in brightness and appear dark against the background.

In the principal analysis of the particles it is for example possible to locate certain molecules within a cell. For example, in the context of the principal analysis it is possible to locate, within a cell, molecules that are marked with a fluorescent dye. The fluorescent dye can for example comprise molecular-biologically produced tags of green fluorescent protein and its derivatives, other autofluorescent proteins. However, fluorescent dyes which establish a covalent or non-covalent bond with a cellular molecule are also suitable as fluorescent dyes. Furthermore, fluorigenic substances can also be used as fluorescent dyes, which fluorigenic substances are converted by cellular enzymes to fluorescent products or so-called FRET pairs (fluorescence resonance energy transfer). The state of the fluorescent dyes used can for example be differentiated by means of their spectral characteristics or by means of bioluminescence.

By means of locating molecules within a cell it is also possible to determine the structure and function of the molecules. It is for example possible to differentiate between their presence in the plasma membrane, in the cytosol, in the mitochondria, in the Golgi apparatus, in endosomes, in lysosomes, in the nucleus, in the spindle apparatus, in the cytoskeleton, co-localisation with actin, tubulin.

Furthermore, within the context of the principal analysis and/or the preliminary analysis the morphology of a cell can be determined. In this process it is also possible to use dyes.

Moreover, within the context of the principal analysis and/or the preliminary analysis two or more states of a cell population can be differentiated.

Furthermore, it is possible within the context of the principal analysis to determine a cellular signal by means of translocation of a fluorescence-marked molecule, e.g. receptor activation followed by receptor internalisation; receptor activation followed by the binding of arrestin; receptor aggregation; transfer of a molecule from the plasma membrane to the cytosol, from the cytosol to the plasma membrane, from the cytosol to the nucleus, or from the nucleus to the cytosol.

Furthermore, it is also possible within the context of the principal analysis and/or the preliminary analysis to determine the interaction between two molecules, wherein preferably at least one of the interacting molecules carries a fluorescence marker, and the interaction is for example shown by collocation of two fluorescent dyes, a FRET or a change in the fluorescence lifetime.

However, it is also possible within the context of the principal analysis and/or the preliminary analysis to determine the status of a cell within a cell cycle, wherein preferably the morphology of the cell or the colouration of the cellular chromatin is evaluated.

A further option in relation to the principal analysis and/or the preliminary analysis consists of determining the membrane potential of a cell, wherein preferably membrane-potential-sensitive dyes are used. Preferably, for this purpose dyes are used which are sensitive in relation to the plasma membrane potential and/or the mitochondrial membrane potential.

Moreover, it is also possible within the context of the principal analysis and/or the preliminary analysis to determine the vitality of a cell, wherein preferably the morphology of the cell is evaluated and/or fluorigenic substances are used which can differentiate between living and dead cells.

Furthermore, in the principal analysis and/or the preliminary analysis it is also possible to analyse cytotoxic effects and/or determine the intracellular ph values.

It is also possible within the context of the principal analysis and/or the preliminary analysis to determine the concentration of one or several ions within a cell.

During the principal analysis and/or the preliminary analysis it is also possible to determine any enzymatic activity within a cell, wherein preferably fluorigenic substances or chromogenic substances, in particular kinases, phosphatases or proteases can be used.

Moreover, it is also possible during the principal analysis and/or the preliminary analysis to determine the production performance of cells that produce biological products such as for example proteins, peptides, antibodies, carbohydrates or fats, wherein one of the described methods can be used.

Finally, within the context of the principal analysis it is also possible to determine cell stress paths, metabolic paths, cell growth paths, cell division paths and other signal transduction paths.

Furthermore, the invention relates to a corresponding analysing device for implementing the above-described method for analysing cells.

The analysing device according to the invention preferably comprises optics in order to take an image of the particles.

Preferably, the optics of the analysing device according to the invention are adjustable to make it possible to set the magnification, the focus and/or the field of vision, or to select a particular optical filter, wherein adjustment of the optics can take place by an actuator (e.g. an electric motor).

It has already been mentioned above that deceleration of the particles preferably takes place by a dielectrophoretic cage, which is known per se. However, in one embodiment of the invention the dielectrophoretic cage is not only used for decelerating the suspended particles for a detailed investigation, but it also functions as a switch or a distribution switchpoint in that the suspended particles, depending on the detailed analysis in the cage, are fed to one of several outlet lines. To this effect, the individual electrodes of the dielectrophoretic cage are preferably selectable independently of each other. Furthermore, to this effect the dielectrophoretic cage is preferably arranged at the branch point of the output lines.

Moreover, a funnel-shaped electrode arrangement can be arranged in one or several of the output lines so as to prevent sinking of the suspended particles in the outlet lines. This is advantageous because the carrier flow in the output lines has a speed profile which shows only a slow flow speed near the wall so that sinking of the particles in the outlet lines could lead to deposits near the wall.

Furthermore, there is the option of supplying the suspended particles by way of two separate carrier flow lines which flow into a common carrier flow line. In this arrangement a dividing wall can be arranged in the common carrier flow line, in the region of the mouth of the two carrier flow lines, which dividing wall in the common carrier flow line separates two separate partial flows, wherein the two partial flows can be analysed. Depending on the result of this analysis, the particles suspended in the two partial flows can then be brought together. The particles brought together can then in the above-described manner be fixed in a dielectrophoretic cage and can be subjected to detailed analysis. Finally, the cells released from the dielectrophoretic cage can then be fed to one of several outlet lines, depending on the result of the detailed analysis.

The invention is particularly advantageous in that cells can be analysed in aseptic conditions or conditions with few germs and can be isolated accordingly.

Other advantageous improvements of the invention are characterised in the dependent claims or are explained below with reference to the figures, in the context of the description of the preferred embodiments of the invention. The following are shown:

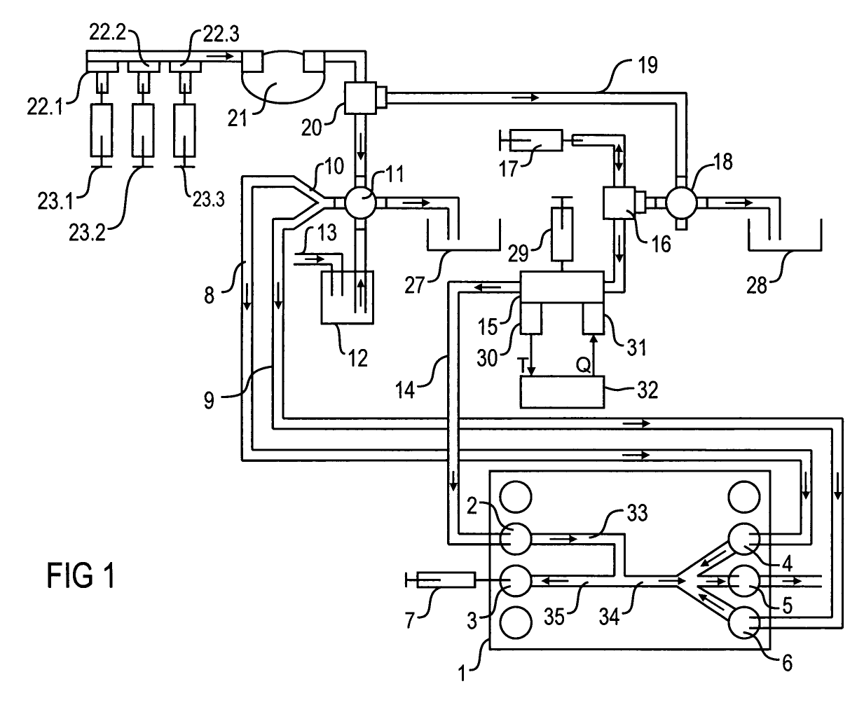

FIG. 1 a fluidic diagram of a cell sorter comprising a sorter chip, according to the invention;

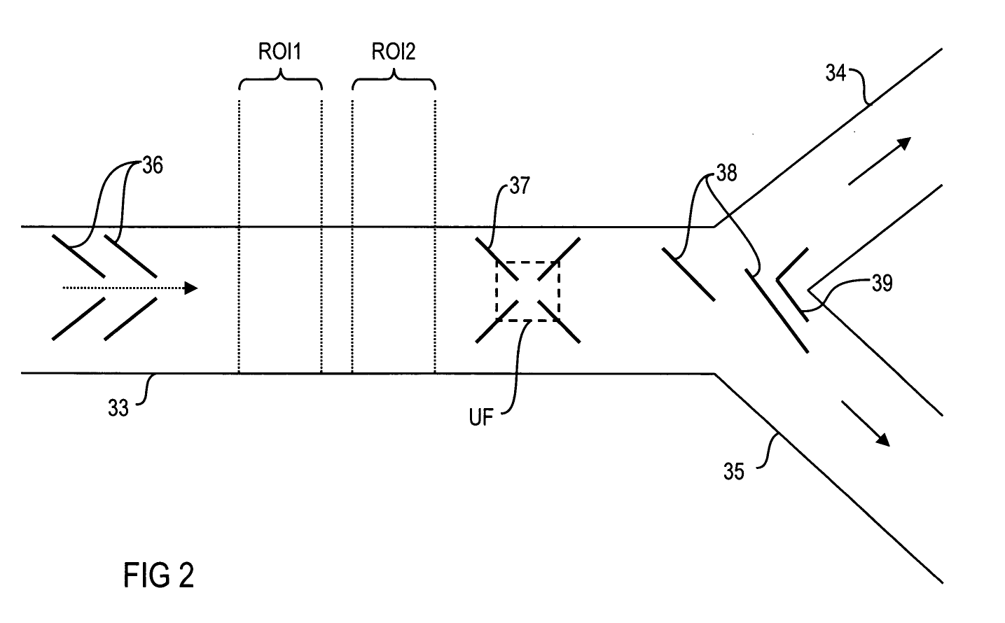

FIG. 2 the carrier flow channel of the sorter chip with several dielectrophoretic elements;

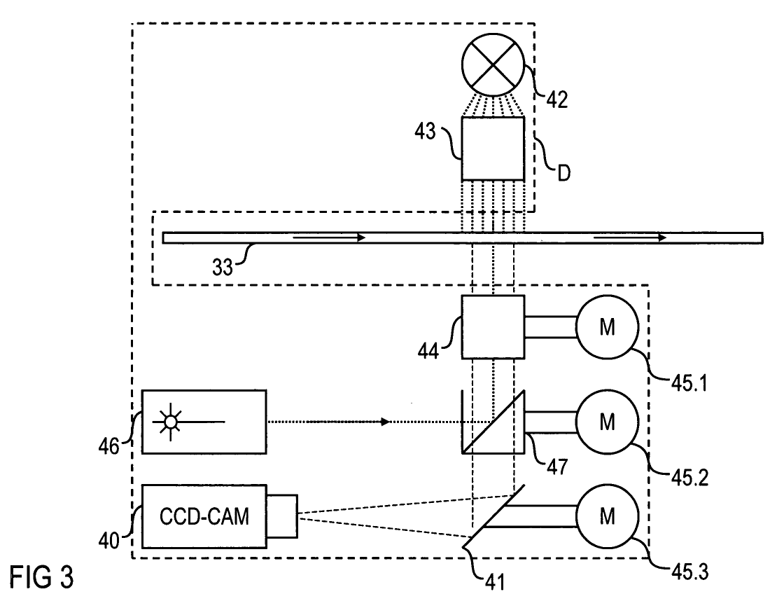

FIG. 3 a diagrammatic representation of the analysing optics of the cell sorter of FIG. 1;

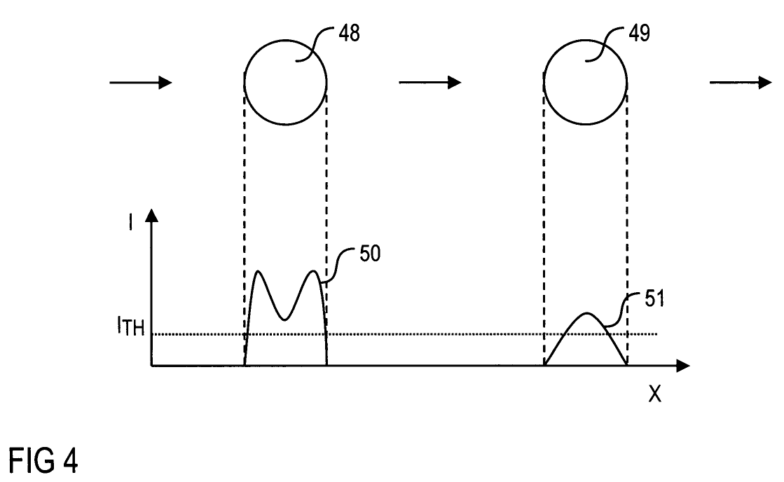

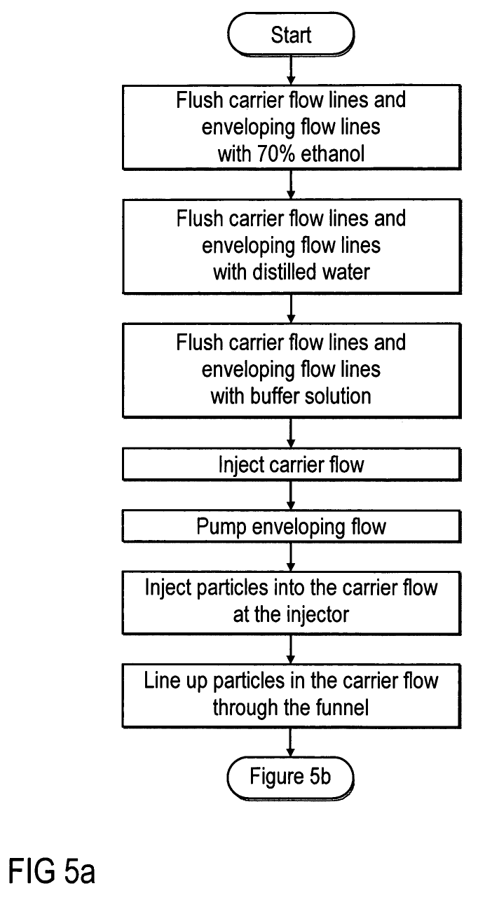

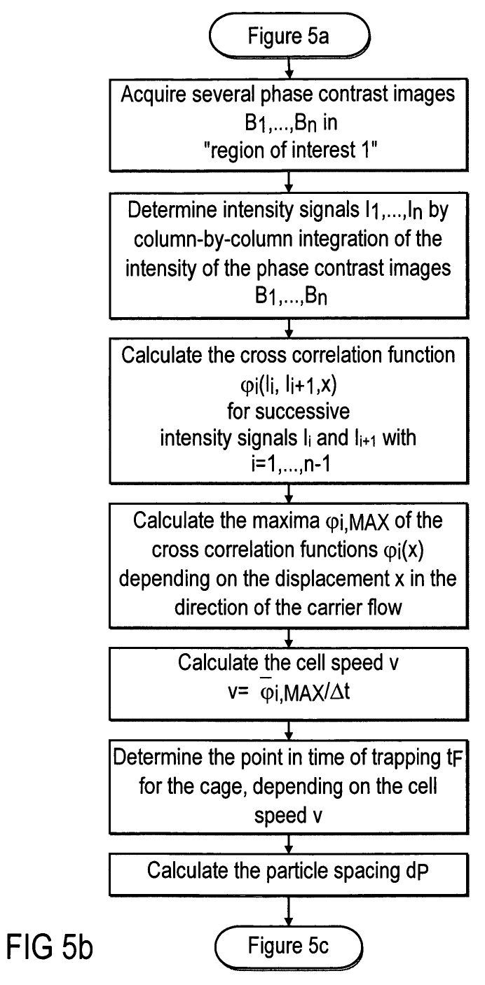

FIG. 4 a diagram to explain the differentiation between dead and living biological cells;

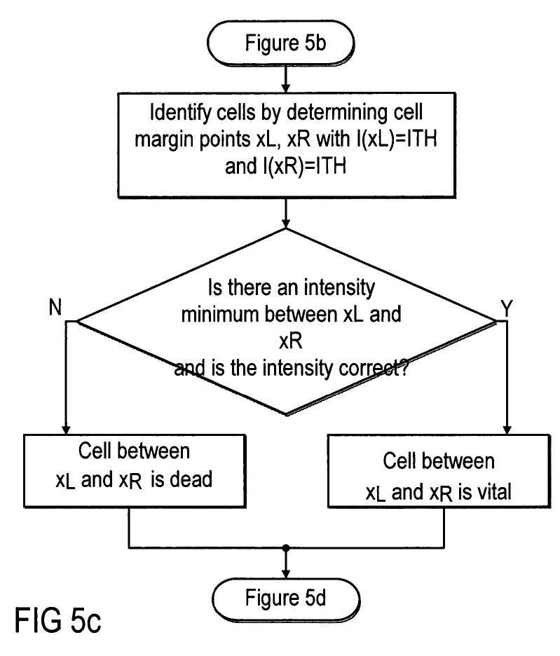

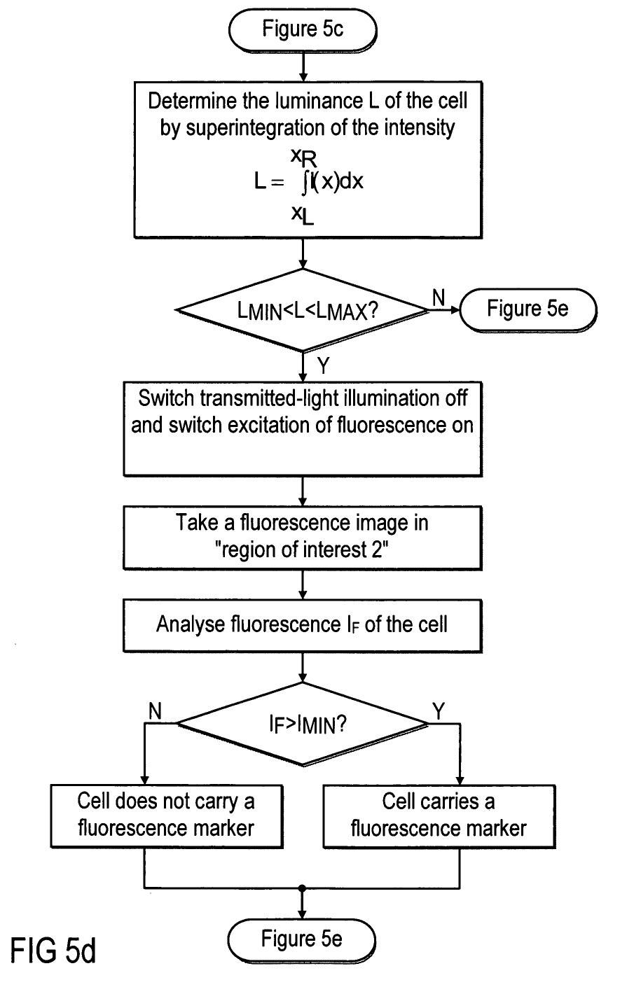

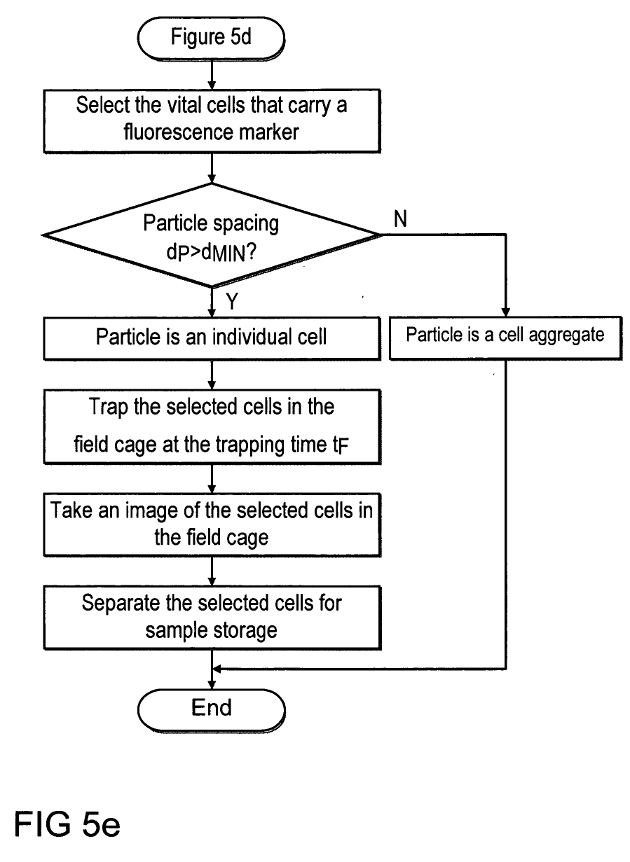

FIGS. 5a-5e an example of the method for analysing cells, according to the invention, in the form of a flow chart; and

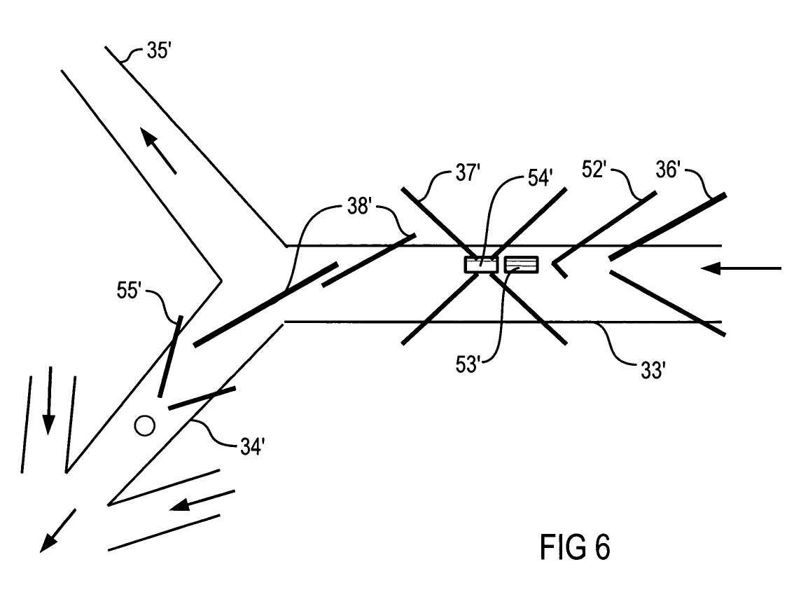

FIGS. 6-9 alternative embodiments of the carrier flow channel of the sorting chip with several dielectrophoretic elements.

The diagram of FIG. 1 shows a cell sorter according to the invention, which cell sorter dielectrophoretically sorts biological cells by means of a microfluidic sorting chip 1.

The techniques of dielectrophoretically influencing biological cells have for example been described in Müller, T. et al.: “A 3-D microelectrode system for handling and caging single cells and particles”, Biosensors and Bioelectronics 14 (1999) 247-256, so that no detailed description of the dielectrophoretic processes in the sorting chip 1 is provided below, but instead in this regard reference is made to the above-mentioned publication.

For fluidic contacting, the sorting chip 1 comprises several connections 2-6, wherein fluidic contacting of the connections 2-6 is described in DE 102 13 272, whose contents shall form part of the present description.

The connection 2 of the sorting chip 1 is used to accommodate a carrier flow with the biological cells to be sorted, while the connection 3 of the sorting chip 1 is used to lead away the selected biological cells which are not further analysed on the sorting chip 1. The selected biological cells can be collected by a suction injector 7 that can be connected to the connection 3 of the sorting chip 1. In contrast to the above, the outlet 5 of the sorting chip 1 is used to lead away the biological cells that are of interest, which biological cells can subsequently be processed or analysed.

Furthermore, the connections 4 and 6 of the sorting chip 1 are used to supply a so-called enveloping flow, whose task it is to lead the selected biological cells to the connection 5 of the sorting chip 1. As far as the function of the enveloping flow is concerned, reference is made to the German patent application DE 100 05 735 so that in the present document there is no need to provide a detailed description of the function of the enveloping flow.

The connections 4 and 6 of the sorting chip are connected by way of two enveloping flow lines 8, 9, a Y-piece 10 and a four-way valve 11 to a pressure vessel 12 in which there is a cultivation medium for the enveloping flow.

The pressure vessel 12 is pressurised by way of a compressed air line 13 so that the buffer solution in the pressure vessel 12 (e.g. a cultivation medium) with a corresponding position of the four-way valve 11 flows to the connections 4, 6 of the sorting chip 1 by way of the Y-piece 10 and the enveloping flow lines 8, 9.

However, as an alternative, the enveloping flow can also be implemented by principles other than through the pressure vessel 12 with the buffer solution, for example using an injector pump or a peristaltic pump.

In contrast to the above, the connection 2 of the sorting chip 1 is connected to a particle injector 15 by way of a carrier flow line 14.

Upstream, the particle injector 15 is connected by way of a T-piece 16 to a carrier flow injector 17, which is manually driven and injects a predetermined liquid flow of a carrier flow.

Furthermore, upstream, the T-section 16 is connected to a three-way valve 20 by way of a further four-way valve 18 and an enveloping flow line 19. The three-way valve 20 makes it possible to flush the enveloping flow lines 8, 9 and the carrier flow line 14 prior to actual operation.

To this effect the three-way valve 20 is connected upstream by way of a peristaltic pump 21 to three three-way valves 22.1-22.3, to which in each case an injector reservoir 23.1-23.3 is connected. In this arrangement the injector reservoirs 23.1-23.3 are used to supply a fill flow for flushing the entire fluidic system prior to actual operation, wherein the injector reservoir 23.1 contains e.g. 70% ethanol while the injector reservoir 23.2 preferably contains distilled water as a fill flow substance. The injector reservoir 23.3 contains e.g. a buffer solution as a fill flow substance.

Furthermore, the cell sorter comprises a collecting vessel 27 for excess enveloping flow, as well as a collecting vessel 28 for excess fill flow.

Below, first the flushing process is described which is carried out prior to the actual operation of the cell sorter to free the enveloping flow line 8, 9, the carrier flow line 14 and the remaining fluidic system of the cell sorter of any air bubbles and impurities.

To this effect first the three-way valve 22.1 is opened, and ethanol from the injector reservoir 23.1 is injected as a filler flow, wherein the peristaltic pump 21 first conveys the ethanol to the three-way valve 20. The ethanol is thus used to reduce the number of germs in the system (so as to establish an aseptic analysis and selection process) and also to completely displace any air from the fluidic system.

During the flushing process the three-way valve 20 is set such that part of the fill flow conveyed by the peristaltic pump 21 is conveyed by way of the fill flow line 19 while the remaining part of the fill flow conveyed by the peristaltic pump 21 reaches the four-way valve 11. The two four-way valves 11, 18 are again set such that the fill flow is conveyed through the enveloping flow lines 8, 9 and the carrier flow line 14. Furthermore, cultivation medium flows from the pressure vessel 12 into the collecting vessel 27 in order to briefly flood the lines.

Following flushing of the cell sorter with ethanol, as described above, flushing with distilled water or a buffer solution is carried out in the same way, wherein in each case the three-way valves 22.2 or 22.3 are opened.

In the flushing process described above, the four-way valve 18 can lead away excess fill flow to the collecting vessel 28.

After the flushing process the three-way valves 22.1-22.3 are closed and the peristaltic pump 21 is switched off.

In order to initiate the sorting operation the four-way valve 11 is set such that the pressure vessel 12 is connected to the Y-piece 10 so that the cultivation medium in the pressure vessel 12 is pushed into the enveloping flow lines 8, 9 as a result of the overpressure in the pressure vessel 12.

Furthermore, during the sorting operation the four-way valve 18 is adjusted such that there is no flow connection between the T-piece 16 and the four-way valve 18.

The carrier flow injected by the carrier flow injector 17 then flows by way of the T-piece 16 into the particle injector 15, wherein a further injector 29 injects biological cells into the carrier flow. Subsequently the carrier flow with the injected biological cells flows from the particle injector 15 by way of the carrier flow line 14 to the connection 2 of the sorting chip.

Furthermore, it should be mentioned that a temperature sensor 30 has been fitted to the particle injector 15 so as to measure the temperature T of the particle injector 15.

Furthermore, both on the particle injector 15 and on the receptacle for the sorting chip 1 there is a temperature control element 31 in the form of a Peltier element so that the particle injector 15 and the sorting chip 1 can be heated or cooled.

In this arrangement, the heating energy or cooling energy Q is specified by a temperature controller 32 which on the inlet side is connected to the temperature sensor 30 and which controls the temperature T of the particle injector 15 to a predefined desired value.

Below, with reference to FIG. 2 a carrier flow channel 33 is described which is arranged in the sorting chip 1 of the cell sorter, wherein said carrier flow channel 33 branches into two outlet lines 34, 35, wherein outlet line 34 is connected to connection 5 of the sorting chip 1 and is used for conveying positively selected particles, while outlet line 35 is connected to connection 3 of the sorting chip 1 and serves to remove the selected particles.

In the carrier flow channel 33, downstream of the connection 2 of the sorting chip 1, a funnel-shaped dielectrophoretic electrode arrangement 36 is arranged whose task it is to line up, in sequence one behind another in the carrier flow channel 33, the particles suspended in the carrier flow. The precise design and the function of the electrode arrangement 36 are described in the publication, mentioned in the introduction, by Müller T. et al., wherein the contents of said publication shall form part of the present description so that below there is no need to provide a detailed description of the electrode arrangement 36.

Downstream of the electrode arrangement 36, a dielectrophoretic cage 37 is arranged in the carrier flow channel 33, which dielectrophoretic cage 37 makes it possible to trap the particles suspended in the carrier flow 33 and to fix said particles in a region of interest UF for in-depth analysis. As far as the design and function of the dielectrophoretic cage 37 is concerned, reference is again made to the cited publication by Müller T. et al., so that there is no need to provide a detailed description in this respect.

Downstream of the dielectrophoretic cage 37, in a branch region of the carrier flow channel 33, there is a sorting device which comprises a dielectrophoretic electrode arrangement 38, wherein as far as the design and function of the electrode arrangement 38 is concerned, reference is also made to the publication by Müller T. et al. cited in the introduction. The electrode arrangement 38 sorts the particles suspended in the carrier flow either into the outlet line 34 or into the outlet line 35, wherein the selection is carried out depending on a principal analysis carried out on the particles fixed in the cage 37, as will be described in detail below.

Furthermore, in the branch region of the carrier flow line 33 a flow guide device is arranged which also comprises a dielectrophoretic electrode arrangement 39 and whose task it is to prevent any reverse flow of particles from the outlet line 35 to the outlet line 34. To this effect the electrode arrangement 39 is v-shaped and comprises two legs, wherein one leg of the electrode arrangement 39 protrudes into the outlet line 34 while the other leg of the electrode arrangement 39 protrudes into the outlet line 35.

Below, with reference to FIGS. 2 and 3, a description is provided of the way the particles suspended in the carrier flow are analysed in the sorting chip 1.

In the context of a preliminary analysis of the particles, first a transmitted-light analysis is carried out in one region of interest ROI1, and a fluorescence analysis is carried out in a further region of interest ROI2, wherein ROI1 is arranged in the carrier flow channel 33 so as to be upstream of the region of interest ROI2 for fluorescence analysis.

Both transmitted-light analysis and fluorescence analysis are carried out by the detection unit D, diagrammatically shown in FIG. 3, which detection unit D for the purpose of image acquisition comprises a CCD camera 40, which is arranged downstream of the sorting chip 1 and is aligned towards a deviation mirror 41.

Above the sorting chip 1 a light emitting diode 42 is arranged as a light source for transmitted-light analysis, wherein between the light emitting diode 42 and the sorting chip 1 a condenser 43 is arranged, which can for example comprise a phase contrast diaphragm.

Below the sorting chip 1, in the optical path of the condenser 43, a lens 44 is arranged.

In the case of a transmitted-light analysis the CCD camera 40 takes an image of the region of interest ROIL by way of the deviation mirror 41 and the lens 44.

Furthermore, the detection unit D comprises several electric motor driven actuators 45.1-45.3, which make it possible to adjust the lens 44, the filter block 47 and the deviation mirror 41. Changing the lens 44 makes it possible to change the magnification and the focus. In contrast to this, the filter block 47 can be adjusted to select different filters. Adjusting the deviation mirror 41 serves the purpose of shifting the field of vision along the carrier flow channel 33 so that any deposits in the carrier flow channel 33 can be detected.

For the purpose of excitation of fluorescence during the fluorescence analysis, the detection unit D comprises a light source 46 (e.g. a laser), which by way of a filter block 47 makes possible excitation of fluorescence of the biological cells suspended in the carrier flow line 33, wherein the CCD camera 40 takes a corresponding fluorescence image.

Below, the various forms of biological cells appearing in the transillumination image are described with reference to FIG. 4. The upper region of FIG. 4 shows a living cell 48 and a dead cell 49, and the lower region shows the associated intensity gradients 50, 51 in the transillumination image. This shows that the living cell 48 has a relatively dark nucleus, while the interior of the dead cell 49 is illuminated evenly. This difference makes it possible to differentiate between a living cell 48 and a dead cell 49, as will be described in detail below.

Below, the method, according to the invention, for analysing cells is described with reference to the flow chart shown in FIGS. 5a to 5e.

At the beginning of the method first the carrier flow line 14 and the enveloping flow lines 8, 9 are flushed with a 70% ethanol solution, then with distilled water and finally with a buffer solution so as to clean the fluidic system of the cell sorter and in particular so as to free it of any air bubbles and impurities.

After this, the carrier flow is injected into the carrier flow line 14 from the carrier flow injector 17, wherein, after the enveloping flow has been supplied, the biological cells to be analysed are injected into the carrier flow by the injector 29 on the particle injector 15 as described below.

Furthermore, the cultivation medium contained in the pressure vessel 12 for the enveloping flow is pushed, by the compressed air supplied by way of the compressed air line 13, from the pressure vessel 12 into the enveloping flow lines 8, 9 which lead to the connections 4 or 6 of the sorting chip 1 and which support further transfer of the particles selected in the sorting chip 1 by way of connection 5 of the sorting chip 1.

In the carrier flow channel 33 of the sorting chip 1, the suspended particles are first aligned, one behind the other in the direction of flow, by the electrode arrangement 36, as is diagrammatically shown by a dashed arrow.

Subsequently, in the region of interest ROI1, several phase contrast images B₁, . . . , Bₙ are taken in succession in order to determine the movement speed of the suspended particles and to differentiate between living cells and dead cells, as will be described in detail below.

In order to determine the movement speed of the suspended particles, for each of the phase contrast images B₁, . . . , Bₙ an intensity signal I₁, . . . , Iₙ is determined in that the image intensity in the phase contrast images B₁, . . . , Bₙ is superintegrated by columns, i.e. at a right angle in relation to the direction of flow. In other words, the individual intensity signals I₁, . . . , Iₙ have a signal peak at the location of a biological cell, wherein a signal peak between the intensity signals I₁, . . . , Iₙ is shifted in accordance with the movement speed of the cells and the time interval between the intensity signals I₁, . . . , Iₙ.

Subsequently, a cross correlation function φᵢ is calculated for subsequent intensity signals Iᵢ, Iᵢ₊₁. Calculating the cross correlation function φᵢ serves to determine the movement speed of the cells in the carrier flow channel 33 of the sorting chip 1 so that the dielectrophoretic cage 37 can be selected at the right point in time to trap a particular cell.

Subsequently, the maximums are calculated for the individual cross correlation functions φᵢ (x) depending on the displacement x in longitudinal direction of the carrier flow channel 33.

The movement speed v of the cells in the carrier flow channel 33 results as a quotient from the average value of the maximums of the cross correlation functions and the time interval between subsequent phase contrast images B₁, . . . , Bₙ.

The movement speed v of the cells can be used within the context of feedback for pump control, i.e. for checking whether the calculated pump rate agrees with the actual pump rate and to what extent any readjustment may have to take place. In particular, the movement speed v can be used to detect whether there are any malfunctions in the system, on the basis of which malfunctions the cells flow too slowly (blockage), are immobile, or even flow backward. All these malfunctions can be detected and remedied in this way, e.g. by flushing the system.

However, as an alternative, the above-described determination of the movement speed v of the cells can also take place outside the regions of interest ROI1, ROI2. Basically, cell tracking within the entire carrier flow channel 33 or within any desired regions of the carrier flow channel 33 is possible.

Furthermore, the signal shape of the intensity signals I₁, . . . , Iₙ provides information about the size of the particles and any aggregate formation. Overall, evaluation of the intensity signals is important for controlling and automating the entire unit, namely the pumps, the dielectrophoretic electrode elements (e.g. when does caging take place and when does switching take place), detailed image capture in the cage 37, and sample storage.

In a further step the point in time of trapping t_{F} is calculated, at which point in time the cage 37 has to be selected in order to trap the analysed particle for the subsequent principal analysis in the region of interest UF. The point in time of trapping t_{F} simply results from the movement speed v of the particle and the distance from the cage 37.

Moreover, in a further step, the particle spacing d_{P} between neighbouring particles is determined. This is important for differentiating between an individual cell and a cell agglomeration, as will be described in detail below.

Below, the process sequence described in FIG. 5c is explained, in which process sequence differentiation between dead cells and live cells takes place. To this effect, cell margin points x₁, xᵣ are determined in which the intensity in the phase contrast image exceeds a predefined threshold value I_{TH}.

Subsequently, a check is made whether there is an intensity minimum between the cell margin points x₁, xᵣ. If this is the case and a minimum intensity is present, then this cell is a living cell, as is shown in FIG. 4. Otherwise the cell is classified as being dead, in order to then carry out a respective selection, as will be described in detail below.

Following the above-described differentiation between dead cells and living cells, in the process sequence shown in FIG. 5d the luminance L of the individual cells is determined in that the intensity I of a cell between the cell margin groups x₁ and xᵣ is superintegrated.

Afterwards the luminance L, determined in this way, of the cell is compared to a minimum value Lₘᵢₙ and a maximum value Lₘₐₓ.

If the determined luminance of the cell is within this region, the transmitted-light illumination is switched off and the excitation of fluorescence by way of the light source 46 is switched on. After this, a fluorescence image is taken in the region of interest ROI2, and the fluorescence I_{F} of the cell is measured.

However, it is also possible to have the excitation of fluorescence switched on permanently, wherein only the transmitted-light illumination is switched off if the determined luminance of the cell is within the above-mentioned region of interest.

If the measured fluorescence I_{F} of the cell exceeds a predetermined limiting value Iₘᵢₙ this indicates that the cell concerned has a fluorescence marker.

In contrast to the above, if the measured fluorescence I_{F} is below the predefined limiting value Iₘᵢₙ it can be assumed that the cell concerned does not carry a fluorescence marker.

In the process sequence shown in FIG. 5e particular cells are then selected, wherein the differentiation between living cells and dead cells as well as the check for any fluorescence marker is taken into account. For example, it is possible to select those cells that are living and carry a fluorescence marker, whereas other cells are deselected.

In a further step, there is a differentiation between individual cells on the one hand and cell aggregation on the other hand, in that the previously determined particle spacing d_{P} is compared to a predefined minimum value d_{MIN}. If the minimum value d_{MIN} is not reached, it is assumed that the particle is a cell aggregate, so that the process is terminated. In contrast to this, if the particle spacing d_{P} exceeds the predefined minimum value d_{MIN}, it is assumed that the particle is an individual cell and the process is continued with the steps described below.

At the predetermined point in time of trapping t_{F} the cells selected in this way are then trapped in the dielectrophoretic cage 37 and are fixed in this way so that subsequently a principal analysis of the trapped cell is possible at a higher resolution and a longer exposure time.

The selected cells, i.e. as a rule the living cells that carry a fluorescence marker, are then allowed by the electrode arrangement 38 to enter the outlet line 34, whereas the deselected cells (e.g. dead cells) are conveyed to the outlet line 35.

The principal analysis in the region of interest UF can involve images with excitation of fluorescence, wherein one or several excitation wavelengths can be used simultaneously or offset in time. To this effect, suitable dichroic mirrors are used in the filter block 47. In this arrangement the fluorescence light of one or several wavelengths is simultaneously channelled to one or several cameras. To this effect suitable emission filter inserts are used in the filter block 47 or suitable emission splitters are used. In this way it is possible to produce, simultaneously or in sequence, images of the selected cell with the use of several fluorescent dyes. Furthermore it is possible to produce an image of the selected cell with white light phase-contrast illumination. This is necessary to detect whether one or several non-fluorescence-marked cells still adhere to a fluorescence-marked cell, which would lead to—normally undesirable—contamination of this single fluorescence-marked cell.

The embodiment shown in FIG. 6 largely corresponds to the embodiment shown in FIG. 2 so that, for the sake of avoiding repetition, reference is made to the above description and, below, identical reference numbers are used for corresponding components, which reference numbers for differentiation have merely been marked with an apostrophe.

One characteristic of this embodiment consists of the simpler construction design of the dielectrophoretic electrode arrangement 36′ arranged on the inlet side of the carrier flow channel 33′, which electrode arrangement 36′ lines up, in sequence one behind the other, in the carrier flow channel 33′, the particles suspended in the carrier flow.

A further characteristic of this embodiment consists of a hook-shaped electrode arrangement 52′, commonly referred to as a “hook”, being arranged in the carrier flow channel 33′ downstream of the electrode arrangement 36′, with the function of this hook being to seize particles and to quasi park them. The precise design and function of the electrode arrangement 52′ is for example described in Müller, T. et al.: “Life Cells in Cellprocessors” in Bioworld 2-2002 so that there is no need to provide a detailed description of the electrode arrangement 52′ in this document, wherein the contents of the above-mentioned printed publication shall to the full extent form part of this description.

In the carrier flow channel 33′ there is a region of interest 53′ between the electrode arrangement 52′ and the dielectrophoretic cage 37′ to carry out the preliminary analysis, described above in relation to the regions of interest ROIL and ROI2.

In this arrangement, a further region of interest 54′ is located in the dielectrophoretic cage 37′ so that in the dielectrophoretic cage 37′ an analysis of the decelerated particles can be carried out.

A further characteristic of this embodiment consists of a funnel-shaped electrode arrangement 55′ being arranged in the outlet line 34′ for the positively selected particles, with the function of said funnel-shaped electrode arrangement 55′ corresponding to the function of the electrode arrangement 36′ and the task of the electrode arrangement 55′ being to centre the particles in the outlet line 34′. This is advantageous because the particles in the outlet line 34′ have a tendency to sink and can therefore settle near the wall where the flow speed is low. The electrode arrangement 55′ prevents such sinking of the particles and in this way keeps the particles in the middle of the outlet line 34′ where the flow speed is at its maximum.

Furthermore, it should be mentioned that the electrode arrangements 36′, 52′ and the dielectrophoretic cage 37′ are arranged off-centre in the carrier flow line 33′. This results in the particles contained in the carrier flow, when they are released from the dielectrophoretic cage 37′, automatically reaching the outlet line 35′ for negatively selected particles if the electrode arrangement 38′ is not selected. This provides an advantage in that the electrode arrangement 38′ needs to be selected only rarely if in the carrier flow only a few particles are contained that are to be positively selected.

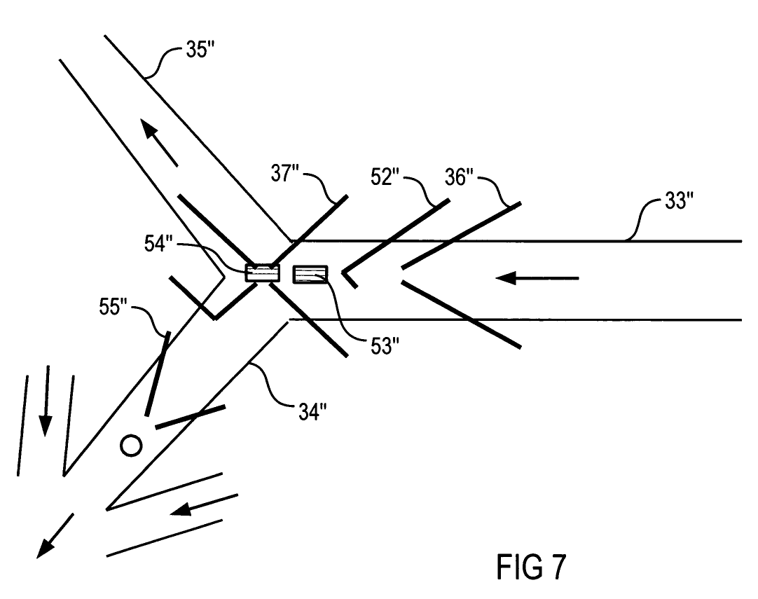

The alternative embodiment shown in FIG. 7 largely agrees with the previously described embodiment shown in FIG. 6 so that, for the sake of avoiding repetition, reference is made to the previous description and, below, identical reference numbers are used for corresponding components, which reference numbers for differentiation have been marked with two apostrophes.

One characteristic of this embodiment consists of the dielectrophoretic cage 37″ being arranged at that position in which the carrier flow channel 33″ branches into the two outlet lines 34″, 35″. Moreover, the individual electrodes of the dielectrophoretic cage 37″ can be selected separately so that the dielectrophoretic cage 37″ can carry out two functions, namely firstly the function of a cage, and secondly the function of a switch or a distribution switchpoint. The dielectrophoretic cage 37″ can thus fix the particles in the carrier flow not only for analysis in the region of interest 54″ but also feed the particles to one of the two outlet lines 34″, 35″.

The term “branch point” used in the context of the present description is to be understood in a general sense rather than being limited to the geometric intersection point of the outlet lines. Instead, it is also possible for the cage 37″ or the distribution switchpoint to be arranged upstream of the intersection point of the outlet lines. For example, the term “branch point” also includes the so-called “separatrix”, i.e. the separation line of the laminar flow in the carrier flow channel.

Furthermore, in this arrangement and in the following embodiments the electrode arrangements 36″, 52″, the cage 37″ and the measuring stations 53″, 54″ are arranged at the centre of the carrier flow channel 33″.

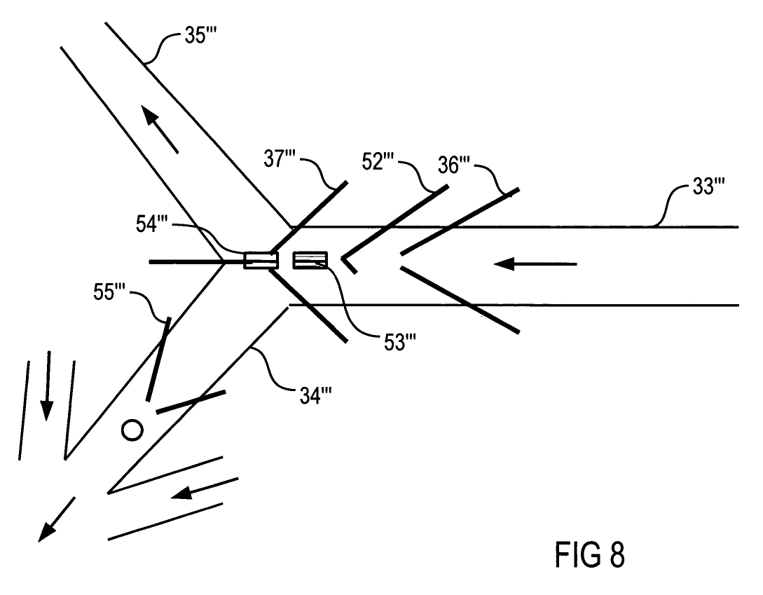

The embodiment shown in FIG. 8 largely agrees with the embodiment described above and shown in FIG. 7 so that, for the sake of avoiding repetition, reference is made to the previous description and, below, identical reference numbers are used for corresponding components, which reference numbers for differentiation have been marked with three apostrophes.

One characteristic of this embodiment consists of the construction of the dielectrophoretic cage 37′″ having only six spatially arranged electrodes, wherein the individual electrodes can be selected separately so that the cage 37′″ can act as a switch or distribution joint or as a cage, as desired.

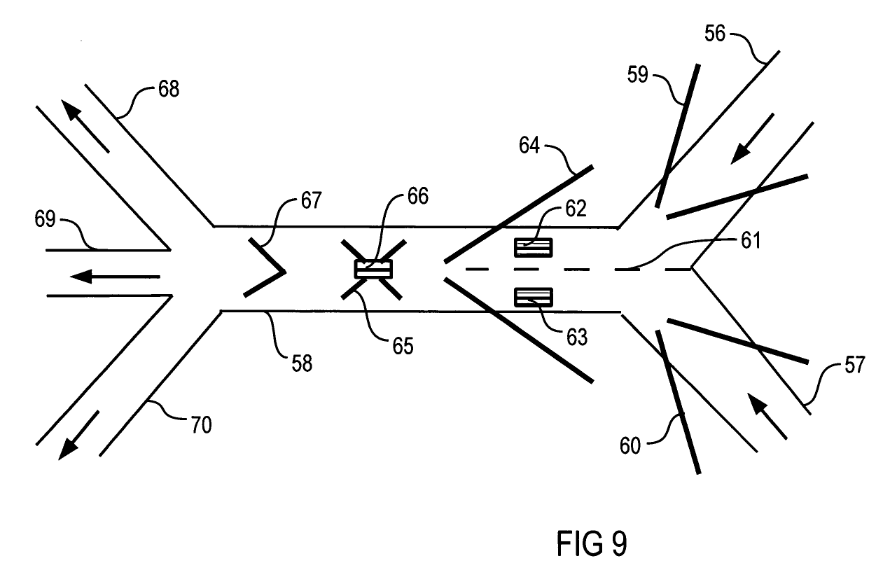

Finally, FIG. 9 shows a further embodiment of a possible arrangement in a sorting chip. In this arrangement two carrier flow lines 56, 57 lead into a common carrier flow line 58, wherein the respectively suspended particles are supplied by way of the two carrier flow lines 56, 57.

A funnel-shaped electrode arrangement 59, 60 is arranged in each of the two carrier flow lines 56, 57 so as to centre the particles contained in the carrier flows of the two carrier flow lines 56, 57.

Upstream in the common carrier flow channel 58, at the point where the two carrier flow lines 56, 57 join, there is a dividing wall 61 so that the particles suspended in the carrier flows of the two carrier flow lines 56, 57 are first guided in the carrier flow line 58 parallel side by side and separately of each other.

In the region of the dividing wall 61 in the carrier flow line 58 there are two regions of interest 62, 63 in order to subject the suspended particles to a preliminary analysis when they flow past, wherein the preliminary analysis can for example be carried out in the manner previously described in the context of FIG. 2.

Downstream of the two regions of interest 62, 63 there is a funnel-shaped electrode arrangement 64 in the carrier flow line 58, wherein said funnel-shaped electrode arrangement 64 centres the particles suspended in the two partial flows on both sides of the dividing wall 61 and feeds said particles to a dielectrophoretic cage 65 which can fix the particles for analysis in a further region of interest 66.

Downstream behind the dielectrophoretic cage 65 there is a further electrode arrangement 67, which after release by the cage 65 feeds the particles suspended in the carrier flow depending on the result of the analysis in the region of interest 66 to any one of three outlet lines 68, 69, 70. In this arrangement the outlet lines 68, 70 are used to lead away the negatively selected particles, while the outlet line 69 is used for onward conveying of the positively selected particles. The electrode arrangement 67 thus has to be actively selected if particles are to be conveyed into the outlet lines 68, 70 for the negatively selected particles, while in contrast to this, no selection takes place for the positively-selected particles. This arrangement is therefore particularly suited to those analyses where only few particles are negatively selected.

The invention is not limited to the preferred embodiments described above. Instead, a multitude of variants and modifications is possible which also utilise the inventive step and thus fall within the scope of the patent.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A method for analyzing particles, in particular for biological particles, with the following steps:
placing the particles to be analysed at least in one carrier flow;
carrying out at least one first analysis of the particles moving with the carrier flow;
selecting at least one particle depending on the result of the first analysis;
decelerating the selected particle; and
carrying out at least one second analysis of the selected particle in the decelerated state.

30. The method for analyzing cells according to claim 29, comprising at least one of the steps of sorting and treating the selected particles depending on the result of the second analysis.

31. The method for analyzing cells according to claim 29, wherein within the scope of at least one of the first analysis and the second analysis at least one of a transmitted-light analysis and a fluorescence analysis is carried out.

32. The method for analyzing cells according to claim 31, wherein the transmitted-light analysis is carried out in a first region of interest and the fluorescence analysis is carried out in a second region of interest, wherein the two regions of interest are spatially separate from each other.

33. The method for analyzing cells according to claim 29, wherein within the scope of the first analysis at least one optical image of the particles is taken.

34. The method for analyzing cells according to claim 29, wherein within the scope of the first analysis at least one of an electrical and electromagnetic analysis is carried out.

35. The method for analyzing cells according to claim 34, within the scope of the first analysis an impedance analysis is carried out.

36. The method for analyzing cells according to claim 29, wherein during the first analysis and the second analysis the particles are analysed morphologically or in relation to their size.

37. The method for analyzing cells according to claim 29, wherein during at least one of the first analysis a check is made whether the particles in the carrier flow comprise a single biological cell or several biological cells, wherein such particles which consist of a single biological cell are selected for the second analysis.

38. The method for analyzing cells according to claim 29, wherein during the first analysis a check is made whether the particles in the carrier flow are living cells or dead cells.

39. The method for analyzing cells according to claim 38, wherein within the scope of the first analysis a transmitted-light analysis of the particles is carried out, wherein an optical image of the particles is taken, and the intensity distribution in the image of the particles is evaluated.

40. The method for analyzing cells according to claim 29, wherein during the first analysis a check is made, by means of a fluorescence analysis, as to whether the particles in the carrier flow exceed a specified threshold for a fluorescence marker.

41. The method for analyzing cells according to claim 29, further for the purpose of deceleration comprising at least one of the steps of fixing the particle that has been selected in the first analysis in a field cage and slowing down the carrier flow.

42. An analyzing device for analyzing particles, in particular biological particles, comprising
a carrier flow channel for accommodating a carrier flow with the particles suspended therein;
a first measuring station for carrying out a first analysis of the particles moving with the carrier flow;
a selection unit for selecting particles depending on the result of the first analysis;
wherein the selection unit comprises a deceleration device for decelerating the selected particles; and
a second measuring station for carrying out a second analysis of the selected particles in the decelerated state.

43. The analyzing device according to claim 42, wherein the second measuring station is arranged downstream of the first measuring station.

44. The analyzing device according to claim 42, wherein downstream of the second measuring station at least one of a treatment device and a sorting device is arranged in order to treat or sort the selected particles depending on the result of at least one of the first and the second analysis.

45. The analyzing device according to claim 44, wherein the carrier flow channel downstream of the second measuring station branches into at least two flow channels, wherein the sorting device is arranged in the branch region of the carrier flow channel.

46. The analyzing device according to claim 45, wherein the sorting device comprises a dielectric distribution switchpoint which is arranged in the branch region of the carrier flow channel.

47. The analyzing device according to claim 45, wherein in the branch region of the carrier flow channel a flow guide device is arranged in order to prevent reverse flow of the carrier flow or of the particles from one of the two flow channels into the other flow channel.

48. The analyzing device according to claim 47, wherein the flow guide device comprises an electrode.

49. The analyzing device according to claim 48, wherein the electrode of the flow guide device is essentially v-shaped and comprises two legs which essentially extend in the direction of the two branching-off flow channels.

50. The analyzing device according to claim 42, wherein the deceleration device comprises a dielectric cage.

51. The analyzing device according to claim 42, wherein focusing electrodes are arranged in the carrier flow channel upstream of the first measuring station.

52. The analyzing device according to claim 42, wherein at least one of the first measuring station and the second measuring station comprises optics for taking an image.

53. The analyzing device according to claim 52, wherein the optics are movable in order to displace the image at least along the carrier flow channel.

54. The analyzing device according to claim 53, wherein for displacing the image, the optics are connected to an electromechanical actuator.

55. Method of using an analyzing device according to claim 42 in at least one of medical or pharmaceutical research, diagnostics and forensic medicine.

56. Method of using an analyzing device according to claim 42 for separating various cell types, for example in particular apoptic and necrotic cells, cells with different expression patterns and/or stem cells.

57. The method for analyzing cells according to claim 30, wherein within the scope of at least one of the first analysis and the second analysis at least one of a transmitted-light analysis and a fluorescence analysis is carried out.

58. The method for analyzing cells according to claim 57, wherein the transmitted-light analysis is carried out in a first region of interest and the fluorescence analysis is carried out in a second region of interest, wherein the two regions of interest are spatially separate from each other.
